(19) United States
(12) Patent Application Publication
(10) Pub. No.: US 2024/0360865 A1
(43) Pub. Date: Oct. 31, 2024

(54) FASTENER LOCK

(71) Applicant: Airbus Operations Limited, Bristol (GB)

(72) Inventors: Andrew CARTER, Bristol (GB); Tony MARKS, Bristol (GB)

(21) Appl. No.: 18/644,841

(22) Filed: Apr. 24, 2024

(30) Foreign Application Priority Data
Apr. 28, 2023 (GB) 2306280.5

(51) Int. Cl. F16B 39/10

(52) U.S. Cl. CPC F16B 39/10

(57) ABSTRACT

An assembly is provided for preventing the relative rotation of a fastener and a nut by way of a nut plate that engages with a drive feature of the nut and a fastener plate that engages with a drive feature of the fastener. The nut plate and fastener plate are secured together to prevent their relative rotation. A base plate is secured to a workpiece in which the nut and fastener are located that is further secured to the nut plate and the fastener plate to prevent the relative rotation of the fastener and nut with respect to the workpiece. The plates have locking members that extend away from the fastener and can be secured together e.g. by drilling and fastening.

### RELATED APPLICATION

This application incorporates by reference and claims priority to Great Britain patent application GB 2306280.5, filed 28 Apr. 2023.

### TECHNICAL FIELD

The present invention relates to an apparatus for preventing relative rotation of a fastener having a drive feature located in its threaded tail and a nut engaged on that threaded tail, and a method for installing the apparatus around such a fastener. The apparatus and method may be particularly suitable for use on aircraft.

### BACKGROUND

Aircraft typically comprise a very large number of separate parts, secured together with fasteners, such as fasteners of the nut and bolt variety. With reference to FIG. 1 an aircraft, 1, is displayed, having wings 2 and a panel of wing skin thereon 12. Such a panel may be secured to the rest of the wing superstructure by way of bolts passing through the wing skin panel 12 and wing superstructure (not visible).

With reference to FIG. 2, a cross section through the wing skin panel (or other similar panel) 12 and aircraft superstructure 14 is shown, fitted together with two fasteners 20 and complementary nuts 30. The wing skin panel 12 and aircraft superstructure 14 together form a workpiece 10 which receives the fasteners 20. These fasteners 20 feature smooth, countersunk heads with no drive feature for engaging with a tool, so as to avoid disturbing the aerodynamic surface of the panel 12. Instead, the fasteners 20 comprise a drive feature 26 in their tails, for engaging with a tool during fastening. The nuts 30 are of a more conventional threaded design with a drive feature provided by their external shape.

Such fasteners 20 and nuts 30 are selected and installed so as to secure the panel for as long as may be required. Aircraft designers may choose appropriate torque values for the fasteners 20 and nuts 30 so as to appropriately secure them together without harming the wing skin panel 12 or aircraft superstructure 14.

In some cases, appropriately torqueing the fasteners 20 and nuts 30 may be insufficient to prevent unwanted rotation of the fasteners 20 and nuts 30, either relative to each other or to the aircraft superstructure 14. Although sealants or adhesives may be used to enhance the security of the fasteners 20 and nuts 30, such products might not always be suitable for use, for example due to the conditions the fasteners 20 and nuts 30 are expected to experience in use.

Accordingly there is a desire to provide an alternative way for preventing unwanted relative rotation of fasteners and nuts.

### SUMMARY

A first aspect of the present invention provides an assembly for preventing the relative rotation of a fastener and a nut, the assembly comprising a nut plate and fastener plate; wherein: the fastener comprises a head, a threaded tail and a fastener drive feature in the tail for rotating the fastener; the nut comprises a threaded hole in which the threaded tail of the fastener is engaged, and a nut drive feature for rotating the nut; the nut plate comprises a nut plate locking member for engaging with the fastener plate, and a nut drive feature engagement member that is coupled to the nut drive feature such that the nut cannot rotate relative to the nut plate; the fastener plate comprises a fastener plate locking member for engaging with the nut plate, and a fastener drive feature engagement member that is coupled to the fastener drive feature such that the fastener cannot rotate relative to the fastener plate; further wherein the nut plate and fastener plate are coupled together via the nut plate locking member and fastener plate locking member such that the fastener and nut cannot rotate relative to each other.

Such an assembly simply prevents the relative rotation of the fastener and nut, and is suitable for retrofitting to a fastener and nut already in situ.

Preferably the nut has an outer perimeter which is shaped to provide the nut drive feature, for driving the nut by a complementarily shaped tool, and the nut plate defines a nut plate hole in which the nut is received, the shape of the nut plate hole being complementary to at least part of the nut outer perimeter so as to provide the nut drive feature engagement member. This provides a secure coupling between the nut and the nut plate.

Preferably the fastener drive feature comprises a shaped recess on the end of the threaded tail distal to the head, and the fastener drive feature engagement member comprises a protrusion that is received inside and coupled to the fastener drive feature. This provides a secure coupling between the fastener and the fastener plate.

Preferably, the nut plate locking member comprises an extended platform around a portion of the circumference of the nut for receiving the fastener plate locking member in different positions depending on the relative angle between the fastener drive feature and the nut drive feature. This permits easy installation of the assembly no matter the initial relative position of the fastener and nut.

Preferably, the fastener plate locking member is connected to the fastener plate by an arm that positions the fastener plate locking member adjacent to a portion of the nut plate locking member. This simplifies securing the fastener plate locking member to the nut plate locking member.

Optionally, the assembly further comprises a base plate, wherein: the workpiece comprises a hole extending between first and second sides of the workpiece, the tail of the fastener is received in the workpiece hole, the fastener head is located on the first side of the workpiece and the nut is located on the second side of the workpiece; the base plate comprises a base plate locking member for engaging with the nut plate and the fastener plate, and base plate securing means for preventing rotation of the base plate relative to the workpiece; further wherein: the base plate, nut plate and fastener plate are coupled together via the base plate locking member, nut plate locking member and fastener plate locking member such that the fastener and nut cannot rotate relative to each other or to the workpiece.

This provides a simple and robust way for preventing rotation of the nut and fastener relative to the workpiece.

Preferably the base plate defines a first hole in which the tail of the fastener is received; and the base plate is positioned between the workpiece and the nut. This helps secure the base plate to the fastener and workpiece.

Preferably, the base defines a second hole, separate to and distant from the first hole, in which a protrusion from the workpiece is received so as to provide the base plate securing means. This helps avoid rotation of the base plate relative to the workpiece.

Preferably the protrusion from the workpiece comprises a second fastener. Accordingly such a base plate can be used to prevent rotation of the first and second fasteners with the help of first and second fastener plates and nut plates.

Preferably the nut plate, fastener plate and base plate are coupled together by way of aligned holes in the nut plate locking member, fastener plate locking member and base plate locking member, the assembly further comprising a plate fastener extending through the holes for preventing relative rotation of the nut plate, fastener plate and base plate. This provides a simple and robust mechanism for securing the plates together.

A second aspect of the present invention provides a kit of parts for fitting to a fastener and nut for preventing their unwanted rotation, the fastener comprising a head, a threaded tail and a fastener drive feature in the tail for rotating the fastener, the nut comprising a threaded hole in which the threaded tail of the fastener is engaged, and a nut drive feature for rotating the nut; the kit of parts comprising: a nut plate, comprising a nut plate locking member and a nut drive feature engagement member for coupling to the nut drive feature such that the nut cannot rotate relative to the nut plate; a fastener plate, comprising a fastener plate locking member, an arm and a fastener drive feature engagement member for coupling to the fastener drive feature such that the fastener cannot rotate relative to the fastener plate; wherein when the nut plate and fastener plate are installed on the nut and fastener respectively, the nut plate locking member and fastener plate locking member are positioned adjacent to each other for securing them together for preventing relative rotation of the nut plate and fastener plate such that relative rotation of the fastener and the nut are prevented.

Such a kit of parts can be fitted to a nut and fastener to prevent their relative rotation quite simply.

A third aspect of the present invention provides a method for installing a first fastener and first nut in a first hole in a workpiece; the fastener comprising a head, a threaded tail and a fastener drive feature in the tail for rotating the fastener, the nut comprising a threaded hole for engaging with the threaded tail of the fastener and a nut drive feature for rotating the nut; the method being for preventing unwanted relative rotation between the first nut and the first fastener, the method comprising: inserting the fastener into the hole in the workpiece; securing the nut on the threaded tail of the fastener on the other side of the hole to the fastener head; providing a nut plate comprising a nut drive feature engagement member for engaging with the nut drive feature and a nut plate locking member, coupling the nut plate with the nut drive feature by way of the nut drive feature engagement member; providing a fastener plate comprising a fastener drive feature engagement member for engaging with the fastener drive feature and a fastener plate locking member; coupling the fastener plate with the fastener drive feature by way of the fastener drive feature engagement member such that the fastener plate locking member and nut plate fastener plate locking member are positioned adjacent to each other; and securing the nut plate and fastener plate together by way of the nut plate locking member and fastener plate locking member such that the fastener and nut can no longer rotate relative to each other.

Such a method allows the nut and fastener to be simply secured to avoid their relative rotation.

Preferably the method further comprises: providing a base plate, comprising a base plate securing means for securing the base plate to the workpiece and a base plate locking member; coupling the base plate to the workpiece by way of the base plate securing means; and securing the base plate, nut plate and fastener plate together by way of the base plate locking member, nut plate locking member and fastener plate locking member, such that the fastener and nut can no longer rotate relative to each other or the workpiece.

Accordingly the relative rotation of the nut and fastener to the workpiece can also be simply prevented.

Preferably, the method further comprises: making a hole that extends through the locking members of the various plates; and securing a locking fastener through the locking members to secure them together to prevent their relative rotation. This is a simple and secure way to lock the plates together.

Preferably, the method is adapted for further installing a second fastener and second nut in a second hole in the workpiece, wherein: the step of providing the base plate comprises providing a base plate comprising a first base plate hole for receiving the first fastener and a second base plate hole for receiving the second fastener, the base plate securing means being provided by the first and second base plate holes being separated from each other such that the base plate cannot rotate around either the first base plate hole or second base plate hole when fasteners extend through them; and the step of coupling the base plate to the workpiece comprises positioning the base plate over the workpiece and first and second fasteners such that the first fastener is received in the first base plate hole and the second fastener is received in the second base plate hole. Accordingly the relative rotation of two fasteners, their nuts and the workpiece can be simply prevented.

### BRIEF DESCRIPTION OF THE DRAWINGS

Embodiments of the invention will now be described, by way of example only, with reference to the accompanying drawings, in which:

FIG. 1 is a perspective view of an aircraft;

FIG. 2 is a cross section view of two fasteners securing two aircraft parts together;

FIG. 3a is a perspective view of a fastener;

FIG. 3b is a perspective view of a nut;

FIG. 4a is a plan view of a first embodiment of a nut plate;

FIG. 4b is a plan view of a second embodiment of a nut plate;

FIG. 5a is a perspective view of a first embodiment of a nut plate;

FIG. 5b is a perspective view of a second embodiment of a nut plate;

FIG. 6a is a perspective view of the parts of an assembly according to a first embodiment ready for joining;

FIG. 6b is a cross section view of the assembly after joining according to a first embodiment;

FIG. 7a is a plan view of a first embodiment of a base plate;

FIG. 7b is a plan view of a second embodiment of a base plate;

FIG. 8a is a cross section view of an assembly according to a second embodiment; and

FIG. 8b is a perspective view of an assembly according to a second embodiment.

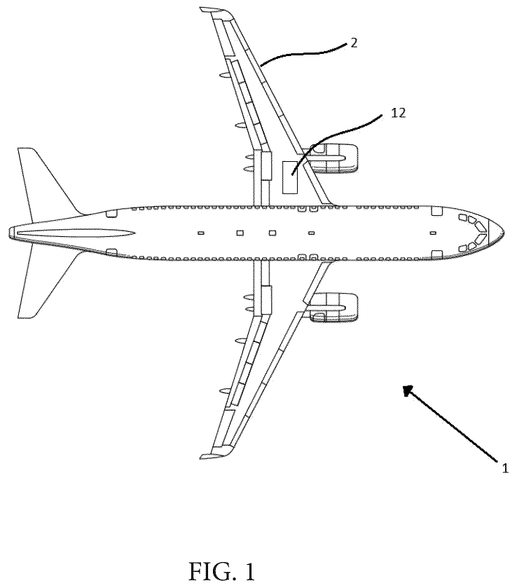

### DETAILED DESCRIPTION

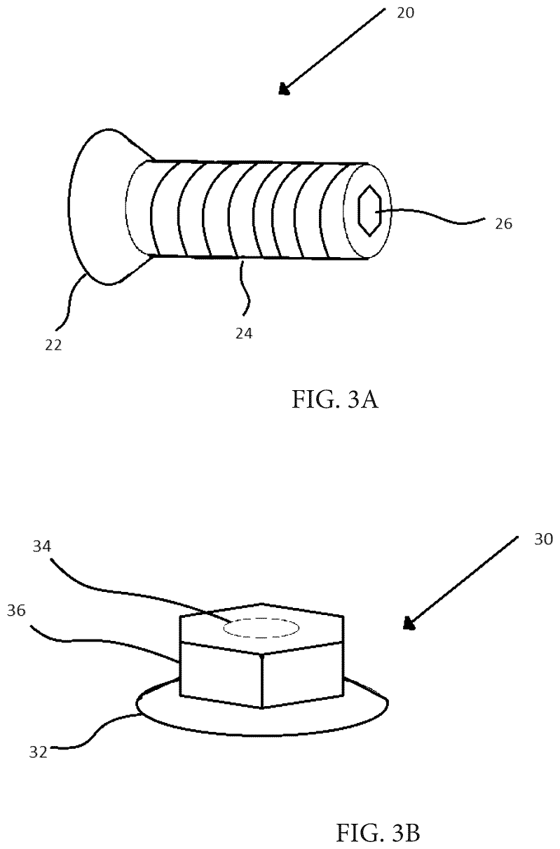

With reference to FIG. 3a, the features of a fastener 20 suitable for use in an embodiment of the present disclosure is shown in more detail. The fastener 20 comprises a head 22 and a threaded tail 24 as is common in most bolts. However, the threaded tail 24 features a fastener drive feature 26 in its end, and the head 22 is designed to be flush and smooth with a workpiece it is inserted into, so as to provide an aerodynamically clean surface.

As shown in FIG. 3a, the fastener drive feature 26 may comprise a recess on the end of the tail 24 opposite to the head 22, shaped so as to engage with a protruding tool—in this case, a hexagonal recess for engaging with a standard hex head. The fastener drive feature 26 allows the fastener 20 to be rotated by a tool. The skilled person will realise that other fastener drive features 26 are also possible, for example a different shape of recess, such as Torx, cross head, flat head or any other appropriate shape for being driven by a tool.

Further alternatively the fastener drive feature 26 may comprise a feature around the end of the tail 24, rather than recessed into the end 24. For example, the tail could end with a shaped outer perimeter such as a hexagon for engaging with a tool in the same manner as a nut.

The threaded tail 24 may be threaded along all or only a portion of its length. Although the head 22 is depicted here to be countersunk in some embodiments the head 22 could be flat, for example if it is intended for receipt in a recess in the surface of a workpiece into which it is intended for insertion.

With reference to FIG. 3b, the features of a nut 30 suitable for use in an embodiment of the present disclosure is shown in more detail. The nut 30 comprises a flared base 32 and a threaded hole 34 for receiving and engaging with the threaded tail 24 of the fastener 20. The nut 30 also comprises a nut drive feature 36 for engaging with a tool for rotating the nut 30.

In this embodiment, the nut drive feature 36 is provided by the outer perimeter of a part of nut 30, which has a hexagonal shape for engaging with a standard tool such as a spanner. The skilled person will realise that other nut drive features are possible, for example a different shape of the outer perimeter of the nut 30 such as square. Further alternatively the nut drive feature 36 could comprise a recess in the nut 30 around the threaded hole 34 for receiving and engaging with a protruding tool.

In some embodiments the flared base 32 may be absent, for example if brinelling of the surface is unlikely to be an issue with the torques used to fasten the nut 30 or if washers are planned for use. Furthermore the threaded hole 34 may feature threading on only a portion of its length.

The components proposed by this disclosure to be used for preventing unwanted relative rotation of fasteners 20 and nuts 30 will now be presented and their use explained. The various components combine to form an assembly around the fastener 20 and nut 30 to prevent the unwanted rotation.

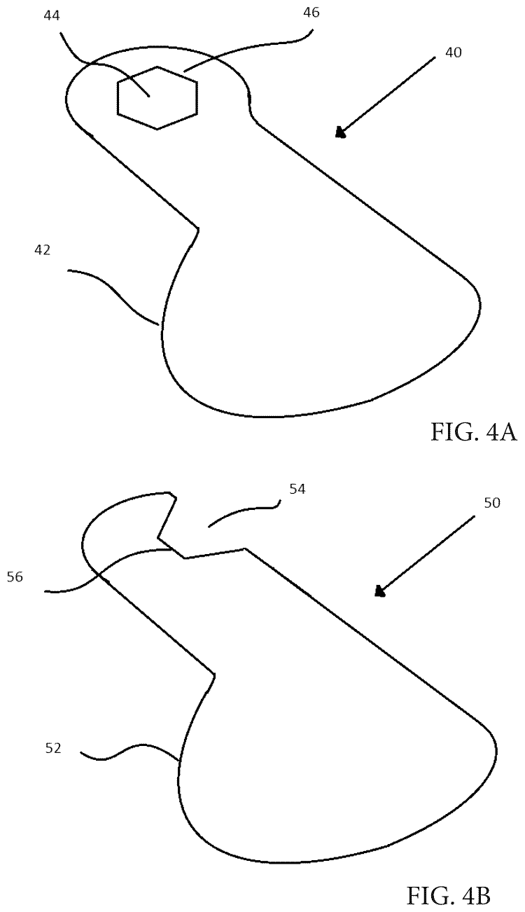

The first component of the proposed assembly is the nut plate, 40, as shown in FIG. 4a. The nut plate is a generally plate-like structure, being flat and relatively thin. It comprises a nut plate locking member 42, an extension of the nut plate through which the nut plate may be coupled to the other components of the assembly. It further comprises a nut drive feature engagement member 46, for coupling to the nut drive feature 36 and preventing relative rotation between the nut plate 40 and the nut 30 when the nut plate 40 is coupled to the nut 30.

In this embodiment, the nut drive feature engagement member 46 is provided by the inner perimeter of a hole 44 in the nut plate 40 for receiving the nut 30. As illustrated the hole 44 has six sides so as to engage with the hexagonal nut drive feature 36 of the nut 30. Alternative nuts 30 with different nut drive features 36 may necessitate alternatively shaped nut drive feature engagement members 46. For example, the hole 44 could be square for engaging the nut drive feature engagement member 46 with a square nut 30.

With reference to FIG. 4b, an alternative nut plate 50 is illustrated. This embodiment features a similar nut plate locking member 52. In this embodiment the nut drive feature engagement member 56 is provided by the inner perimeter of a recess 54 in the nut plate 50 for receiving the nut 30. The nut drive feature engagement member 56 is again shaped complementarily to the intended nut drive feature 36 for engaging with the nut 30, so may be a portion of a hexagon in one embodiment as illustrated here.

Having a recess 54 or partial hole may make installing the nut plate 50 upon the nut 30 easier, for example if the nut 30 is located in a confined space.

As an alternative to the shaped perimeter of the hole 44, 54 providing the nut drive engagement feature 46, 56, the nut drive feature engagement member 46, 56 could be provided by protrusions from the nut plate 40, 50 in the case that the nut drive feature 36 of the nut 30 comprises a recess in the nut 30 around the threaded hole 34.

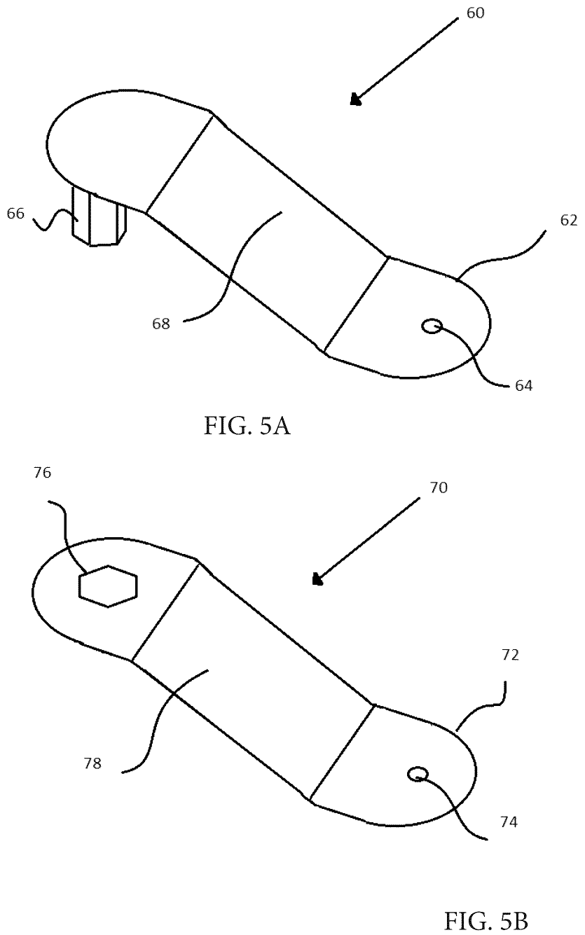

The second component of the proposed assembly is the fastener plate, 60, as shown in FIG. 5a. The fastener plate 60 is formed from a flat piece of material in a general elongated shape. The fastener plate 60 comprises a fastener plate locking member 62 on the one end of the fastener plate 60 for coupling with the nut plate 40 by way of the nut plate locking member 42. The fastener plate locking member 62 may comprise a pre-drilled pilot hole 64 to aid in securing the fastener plate 60 to the nut plate 40.

The fastener plate 60 further comprises a fastener drive feature engagement member 66 on the opposite end of the fastener plate 60 to the fastener plate locking member 62. In this embodiment, the fastener drive feature engagement member 66 comprises a protrusion on the underside of the fastener plate 60 for protruding into a recess on the end of the tail 24 and engaging with the fastener drive feature 26 of the fastener 20. The drive feature engagement member 66 may have a hexagonal cross section for engaging with a hexagonal recess. Alternatively the drive feature engagement member 66 may have any other shape that engages with the fastener drive feature 24 so as to prevent the relative rotation of the fastener 20 and the fastener plate 60.

Although the fastener plate 60 regions around the fastener plate locking member 62 and fastener drive feature engagement member 66 are generally parallel to each other they are preferably not coplanar. In FIG. 5a this is provided by arm 68, where the plate from which the fastener plate 60 is made has been bent so as to move the fastener plate locking member 62 towards the same direction as the protruding fastener drive feature engagement member 66.

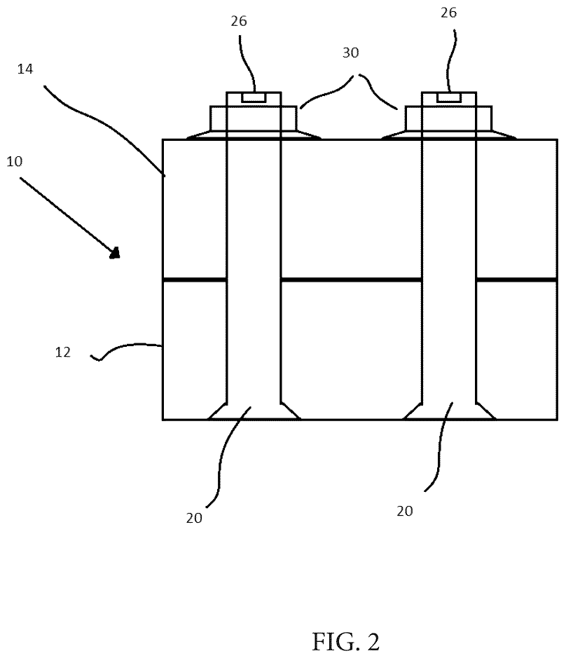

With reference to FIG. 2 the reason for this can be seen—the fastener drive feature 26 is located higher up i.e. further from the workpiece 10 in the assembly than the nut drive feature 33. Accordingly, if the fastener plate 60 did not comprise the arm 68, the plate-like nut plate 40 and fastener plate 60 would extend out from the relevant feature they are engaged with on the fastener 20 and nut 30, and the nut plate locking member 42 and fastener plate locking member 62 would have a significant distance between them. Accordingly the arm 68 serves to bring the fastener plate locking member 62 adjacent to and parallel with a portion of the nut plate locking member 42, thus making it simpler to couple together the nut plate 40 and fastener plate 62 by way of their respective locking members 42, 62.

Instead of the plate-like fastener plate 60 being bent to create the arm 68 the skilled person will realise that other alternatives are also suitable for bringing the fastener plate locking member 62 close to the nut plate locking member 42. For example, the fastener plate 60 could be moulded into an appropriate shape rather than bent from a sheet of material. Particularly when moulded the fastener plate 60 may provide the arm 68 by being thicker in the region of the fastener plate locking member 62. Further alternatively, the arm 68 could comprise a gradual curve rather than discrete bends as shown in FIG. 5a.

The skilled person will also realise that the degree by which the arm 68 needs to be bent will depend on the relative heights above the workpiece 10 of the fastener drive feature 26 and nut drive feature 36. These differences can be provided for by providing different fastener plates 60 having a different vertical separation between the fastener plate locking member 62 and the fastener drive feature engagement member 66. Alternatively and particularly in the case of a discretely bent fastener plate 60 as shown in FIG. 5a, the already present bends may be amenable to further bending so as to position the fastener plate locking member 62 and the nut plate locking member 42 more closely together.

Further alternatively, the nut plate 40 may also be bent up so as to bring the lock plate locking member 42 closer to the fastener plate locking member. This may be in addition to or instead of the fastener plate 60 comprising an arm 68 to bring the fastener plate locking member 62 close to the nut plate locking member 42.

With reference now to FIGS. 4a and 5a the reason now for the nut plate locking member 42 being substantially larger than the fastener plate locking member 62 can be seen. There are a range of possible angles between the drive features 26, 36 of the fastener 20 and nut 30 when they have been appropriately torqued together. Accordingly, the nut plate locking member 42 comprises an extended platform around a portion of the circumference of a nut 30 when received in the nut plate hole 44 for receiving the fastener plate locking member 62 in different positions depending on the relative angle between the fastener drive feature 26 and the nut drive feature 36.

In an embodiment where the fastener drive feature 26 and nut drive feature 36 are both hexagonal, the difference between the two drive features 26, 36 may be as much as one-sixth of a circle i.e. up to 60 degrees. Accordingly the nut plate locking member 42 extends approximately 60 degrees around the nut plate hole 46. In this way, whatever the final angle between the fastener drive feature 26 and nut drive feature 36, the fastener plate 60 can always be engaged with the fastener 20 (via the fastener drive feature 26 and fastener drive feature engagement member 66) in such a way so as to position the fastener plate locking member 62 adjacent to the nut plate locking member 42.

In other embodiments the nut plate locking member 42 may extend more than 60 degrees around the nut plate hole 44 so as to allow for further flexibility in positioning the fastener plate 60 relative to the nut plate 40. Furthermore, in embodiments where the fastener drive feature 26 has a different shape other than hexagonal, the nut plate locking member 42 may extend at least a different angle around the nut plate hole 44 so as to provide similar functionality. For example, if the fastener drive 26 feature is square or a cross head, the nut plate locking member 42 may extend at least approximately 90 degrees around the nut plate hole 44.

With reference to FIG. 5b, an alternative embodiment of the fastener plate 70 is depicted. In this embodiment the fastener drive feature engagement member 76 comprises a shaped hole, which is particularly suitable for engaging with a fastener drive feature 26 that extends around the end of the tail 24, such as a hexagonal outer perimeter. Again the fastener drive feature engagement member 76 is preferably shaped to engage with the fastener drive feature so as to prevent rotation between the fastener 20 and the fastener plate 70.

The fastener plate 70 comprises a fastener plate locking member 72 on the one end of the fastener plate 70 for coupling with the nut plate 40 by way of the nut plate locking member 42. The fastener plate locking member 72 may comprise a pre-drilled pilot hole 74 to aid in securing the fastener plate 70 to the nut plate 40. The fastener plate 70 may also feature an arm 78 in the same way as the fastener plate 60 of FIG. 5a.

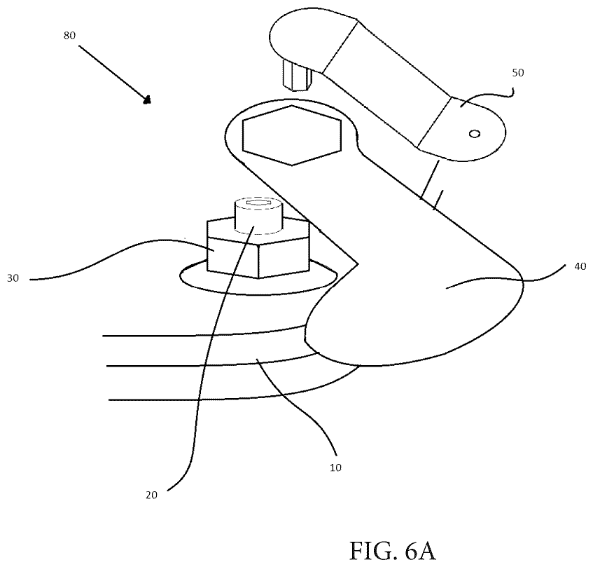

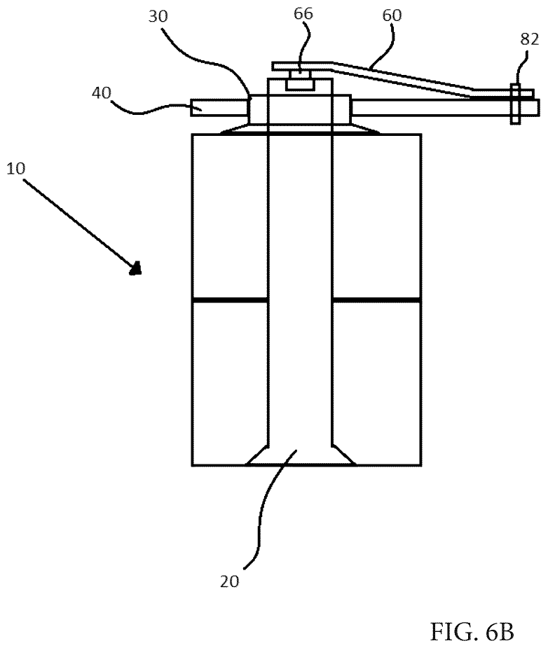

With reference now to FIG. 6a, the parts of the assembly 80 are shown ready for joining. The workpiece 10 comprises a hole extending between first and second sides of the workpiece 10. The tail 24 of a fastener 20 extends through the hole in the workpiece 10, with the head 22 being located on the first side of the workpiece. The nut 30 is located on the second side of workpiece 10 and is secured on and engaged with the threaded tail 24 of the fastener 20 by way of the threaded hole 34.

The nut plate 40 is ready for placing over the fastener 20 and nut 30 for receiving the nut 30 within the nut plate hole 44 and engaging with the nut drive feature 36 by way of the nut plate drive feature engagement member 46. The fastener plate 60 is ready for placing over the fastener 20 for coupling to and engaging with the fastener drive feature 26 by way of the fastener drive feature engagement member 66.

With reference now to FIG. 6b, the assembly 80 is shown as complete. The nut drive feature engagement member 46 is coupled to the nut drive feature 36 such that the nut 30 cannot rotate relative to the nut plate 40. The fastener drive feature engagement member 66 is coupled to the fastener drive feature 26 such that the fastener cannot rotate relative to the fastener plate 60.

The nut plate 40 and fastener plate 60 are coupled together via the nut plate locking member 42 and the fastener plate locking member 62 such that the fastener 20 and nut 30 cannot rotate relative to each other. The locking members 42, 62 are coupled together by way of a locking fastener 82 that extends through a hole in both the fastener plate locking member 62 and the nut plate locking member 42.

Locking fastener 82 may be any appropriate fastener, such as a nut and bolt, a rivet or similar. Alternatively, the locking members 42, 62 may be coupled together in any other appropriate way for preventing their relative rotation. For example, they could be adhered together, welded together or crimped together depending on their material composition.

As described above, the fastener plate 60 may feature a locking member pilot hole 64 which could be used as a guide to drill a hole through the nut plate locking member 42 for coupling together the nut plate locking member 42 and fastener plate locking member 62.

As shown in FIG. 6a, the nut plate 40 and fastener plate 60 can be added to a fastener 20 and nut 30 in situ in a workpiece 10. This makes them particularly suitable for retrofitting the assembly 80 around such a fastener 20 and nut 30. To that end the nut plate 40 and fastener plate 60 may be provided as a kit of parts for fitting to a fastener 20 and nut 30 for preventing their unwanted rotation.

The assembly 80 can be installed or retrofitted around an existing fastener 20 and nut 30 engaged with the fastener 20 by providing the nut plate 40 and fastener plate 60; coupling the nut plate 40 with the nut drive feature 36 by way of the nut drive feature engagement member 46; coupling the fastener plate 60 with the fastener drive feature 26 by way of the fastener drive feature engagement member 66 such that the faster plate locking member 62 and nut plate fastener locking member 42 are adjacent to each other; and securing the nut plate 40 and fastener plate 60 together by way of the nut plate locking member 42 and the fastener plate locking member 62 such that the fastener 20 and nut 30 can no longer rotate relative to each other.

In one embodiment, the assembly 80 can be assembled using a new fastener 20 and nut 30 or ones which do not start off inserted into the workpiece 10. Accordingly the method of installing the assembly 80 may also include steps of inserting a fastener 20 into a hole in the workpiece 10 and securing the nut 30 on the threaded tail 24 of the fastener 20 on the other side of the hole in the workpiece 10 to the fastener head.

The arrangement shown in FIG. 6b is particularly suitable for preventing unwanted rotation of the fastener 20 relative to the nut 30. However, the fastener plate 60 and nut plate 40 may still permit relative rotation between the fastener 20 and nut 30 on the one hand and the workpiece 10 on the other hand. Furthermore the assembly 80 can be removed from the fastener 20 and nut 30 in some embodiments by vertically pulling the component parts away from the fastener 20.

The assembly 80 and its various components as described above are particularly suitable for preventing relative rotation of a fastener 20 and a nut 30. In some cases it may also be desirable to prevent relative rotation between the fastener 20, nut 30 and workpiece 10. Furthermore, it may be desirable to inhibit removal of the nut plate 40 and fastener plate 60. One way to achieve this is the locking fastener 82 may extend into the workpiece 10. For example, the locking fastener 82 could be provided with a thread, and a threaded hole could be provided in the workpiece to receive such a locking fastener 82. This would also inhibit the relative rotation of the fastener 20 and nut 30 on the one hand and the workpiece 10 on the other hand.

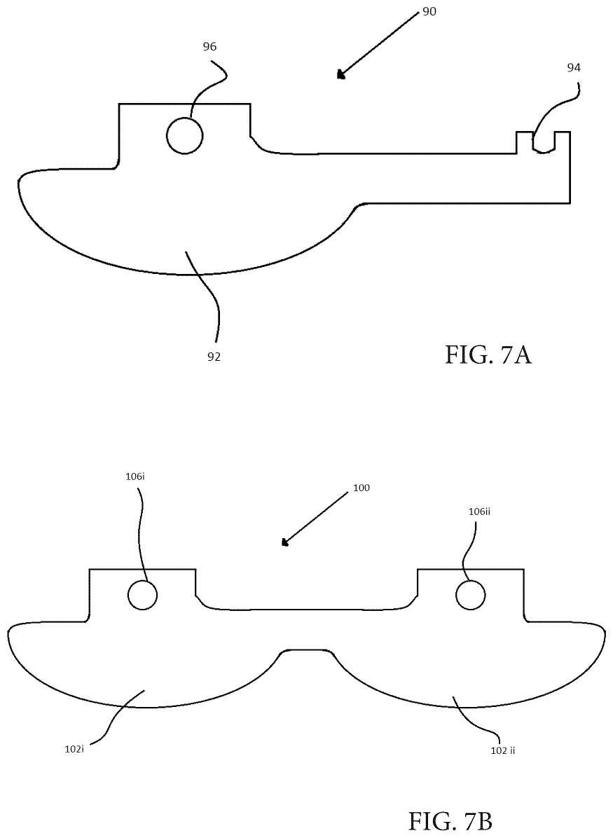

Alternatively, a further component may be provided to inhibit relative rotation of the fastener 20 and nut 30 on the one hand and the workpiece 10 on the other hand. Such a component could also inhibit removal of the nut plate 40 and fastener plate 60. Such a further component of the assembly for achieving that end is now described with reference to FIG. 7a.

This third component of the assembly is the base plate 90. The base plate has the function of coupling to both the nut plate 40 and fastener plate 60 as well as the workpiece 10 for preventing relative rotation of the assembly with respect to the workpiece.

The base plate 90 comprises a base plate locking member 92 for engaging with the nut plate 40 and the fastener plate 60 by way of their respective locking members 42, 62. In order to position the base plate locking member 92 appropriately with respect to the other plates 40, 60 the base plate 90 may feature a base plate hole 96 suitable for receiving the threaded tail 24 of the fastener 20. However in some embodiments this hole may be omitted since the base plate 90 may be appropriately held in position by other methods before the securing of the plates 40, 60, 90 together. The base plate hole 96 if present is preferably sized so as to just accept the fastener 20 to avoid allowing too much motion in the base plate 96.

The base plate further comprises a base plate securing means 94 for preventing rotation of the base plate relative to the workpiece 10 around the axis of the fastener 20. This base plate securing means 94 couples to the workpiece 10 at a remove from the axis of the fastener 20, thereby preventing rotation around the fastener 20 when secured to the workpiece 10. As illustrated in FIG. 7a, base plate securing means 94 may comprise one or more protrusions for engaging with a feature on the workpiece 10, such as a recess shaped to receive the base plate securing means 94. Alternatively, the workpiece 10 may comprise a protrusion that is received between and engaged with the protrusions of the base plate securing means 94. If the workpiece 10 comprises a protrusion then the base plate securing means 94 may comprise a hole in the base plate 90 sized to receive that protrusion.

Similarly to the nut plate locking member 42, the base plate locking member 92 comprises an extended platform some distance around the circumference of the fastener 20, so as to support and/or couple effectively with the nut plate 42 in the different possible positions it may occupy according to the position of the nut 30 when torqued into the workpiece. Preferably the base plate locking member extends around a larger circumference of the fastener 20 than the nut plate locking member 42 so as to provide a good base for supporting the nut plate locking member 42 as well as providing more options for locating the nut plate 40 around the nut 30. For example, the base plate locking member 92 may extend approximately 90 degrees around the fastener 20.

In order to bring the base plate locking member 92 into close proximity with the nut plate locking member 42 the base plate locking member may be bent or extended away from (upwards from) the workpiece 10. Alternatively, the nut plate locking member 42 and fastener plate locking member 62 may both extend towards (downwards towards) the workpiece 10 so as to bring them into close proximity with the base plate locking member.

With reference now to FIG. 7b, an alternative base plate 100 is shown particularly suitable for use with two adjacent fasteners, each of which may receive their own nut plate 40 and fastener plate 60. The base plate 100 features two base plate locking members 102i, 102ii for engaging respectively with a nut plate 40i, 40ii and a fastener plate 60i, 60ii. These base plate locking members 102i, 102ii may be distinct regions of the base plate 100 or be combined into one large base plate locking member that can support and engage with two nut plate locking members 42i, 42ii.

The base plate 100 further feature a first hole 106i and a second hole 106ii, each for receiving the respective first and second fasteners 201, 20ii. Since the fasteners are separated within the workpiece 10 each of the first hole 106i and second hole 106ii act as the base plate securing means for the other, each preventing rotation of the base plate 100 around the other hole 106i, 106ii. The holes are preferably sized so as to just accept the threaded tail 24 of fastener 20 in order to minimise any possible motion in the base plate 100. In some cases this may be an interference fit, with the threaded tail 24i, 24ii of the fastener 20i, 20ii actively engaging with the base plate 100.

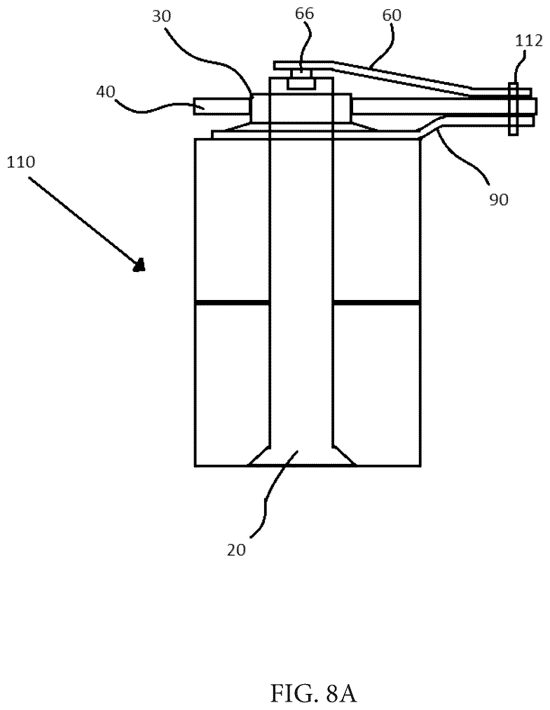

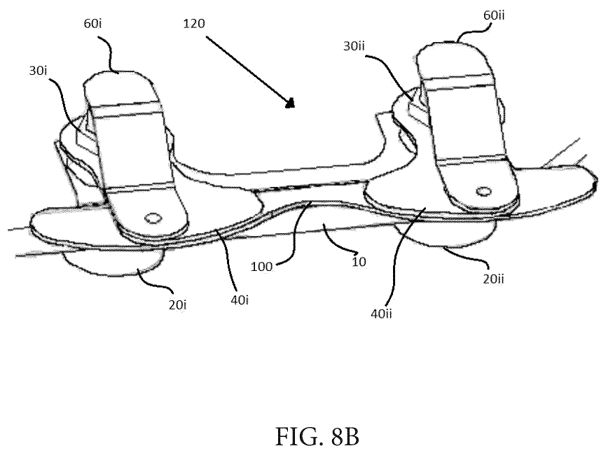

With reference now to FIG. 8a, the components of the assembly 110 are shown installed around a fastener 20 and nut 30 installed in a workpiece 10. The base plate 90, nut plate 40 and fastener plate 60 are all in situ. The nut drive feature engagement member 46 is coupled to the nut drive feature 36 such that the nut 30 cannot rotate relative to the nut plate 40. The fastener drive feature engagement member 66 is coupled to the fastener drive feature 26 such that the fastener cannot rotate relative to the fastener plate 60. The base plate securing member 94 is coupled to the workpiece 10 (not shown) for preventing rotation of the base plate relative to the workpiece or around the fastener 20. In this particular embodiment, the base plate 90 comprises a base plate hole 96 in which the threaded tail 24 of the fastener 20 is received and therefore the base plate 90 extends between the nut 30 and workpiece 10 to go around the fastener 20. In other embodiments lacking the hole 96 the base plate 90 may not extend between the nut 30 and workpiece 10.

The base plate 90, nut plate 40, and fastener plate 60 are coupled together via the base plate locking member 92, the nut plate locking member 42, and the fastener plate locking member 62 such that the fastener 20 and nut 30 cannot rotate relative to each other or relative to the workpiece 10. The locking members 92, 42, 62 are coupled together by way of a locking fastener 112 that extends through a hole in the fastener plate locking member 62, the nut plate locking member 42 and base plate locking member 92.

Locking fastener 112 may be any appropriate fastener, such as a nut and bolt, a rivet or similar. Alternatively, the locking members 92, 42, 62 may be coupled together in any other appropriate way for preventing their relative rotation. For example, they could be adhered together, welded together or crimped together depending on their material composition. Further alternatively one or more of the locking members 92, 42, 62 may be coupled to only one other locking member 92, 42, 62, provided that their relative rotation is still prevented.

As described above, the fastener plate 60 may feature a locking member pilot hole 64 which could be used as a guide to drill a hole through the nut plate locking member 42 and base plate locking member 92 for coupling together the base plate locking member 92, the nut plate locking member 42, and the fastener plate locking member 62.

In some embodiments, the base plate 90, nut plate 40 and fastener plate 90 may be provided as a kit of parts, either for retrofitting around a fastener 20 and nut 30 in situ in a workpiece 10 or for installation with/alongside a fastener 20 and nut 30, for preventing the unwanted rotation of the fastener 20 and nut 30 relative to each other or the workpiece 10.

The assembly 110 may be assembled in a similar way to that described above, with the added steps of providing the base plate 90, coupling the base plate 90 to the workpiece 10 by way of the base plate securing means 94, and coupling the base plate locking member 92 with the nut plate locking member 42 and the fastener plate locking member 62 such that the fastener 20 and nut 30 can no longer rotate relative to each other or the workpiece 10.

With reference now to FIG. 8b an assembly 120 is shown installed in situ around a first and second fasteners 20i, 20ii (shown with protruding heads 22i, 22ii for clarity) in a workpiece 10 using the base plate 100. The base plate 100 sits between the workpiece 10 and the first and second nuts 30i, 30ii, with the threaded tails 24i, 24ii of the first and second fasteners being received in the first and second holes 106i, 106ii. Accordingly the fasteners 20 prevent the rotation of the base plate 90 with respect to the workpiece. The first and second nuts 30i, 30ii are in place on the first and second fasteners 20i, 20ii with the threaded holes 34i, 34ii being engaged on the threaded tails 24i, 24ii. The first and second nut plates 40i, 40ii are engaged with the nut drive features 36i, 36ii by way of the nut drive feature engagement members 46i, 46ii so that the first and second nut plates 40i, 40ii cannot rotate relative to the nuts 30i, 30ii.

The first and second fastener plates 60i, 60ii are in place with the fastener drive feature engagement members 66i, 66ii being engaged with the fastener drive features 26i, 26ii so that the first and second fastener plates 60i, 60ii cannot rotate relative to the fasteners 30i, 30ii. The locking members 102i, 42i, 62i and 102ii, 42ii, 62ii are coupled together respectively by way of locking fasteners 122i, 122ii. The locking members may alternatively be coupled together in any other appropriate way as described elsewhere in this document.

Accordingly the assembly 120 acts to secure the first and second fasteners 20i, 20ii and first and second nuts 30i, 30ii, preventing their relative rotation between themselves or with the workpiece 10. Such an assembly can be installed in a similar way to that previously described, with the added steps of providing the base plate and positioning the base plate over the first and second fasteners 20i, 20ii in the workpiece such that the first fastener 20i is received in the first base plate hole 106i and the second fastener is received in the second base plate hole 106ii.

The components of the assembly described above could be manufactured using any appropriately rigid material that is appropriate for the application they are to be used in. Steel has been found to be particularly appropriate, allowing the thickness of the various plates to be minimised while still providing adequate strength.

Although the invention has been described above in relation to securing a wing skin panel to a wing superstructure, the skilled person will realise that the embodiments described herein are suitable for use in any context where such fasteners 20 and nuts 30 are used. These might be to avoid drag from a fluid e.g. on watercraft, aircraft, spacecraft or structures that interact with a fluid such as wind turbines or underwater installations. Furthermore such fasteners 20 might be used to avoid protruding features on a surface so as to improve safety or accessibility.

The parts and methods described above may be particularly suitable for retrofitting to fasteners 20 and nuts 30 that are already in place and have been found to demonstrate unwanted rotation. In such cases the invention may be used with the fastener 20 and nut 30 already in place. Alternatively the fastener 20 may be replaced with a new one, for example in order to provide extra length to accommodate the parts of the assembly 110. The fastener 20 and or nut 30 may be replaced so as to remove possible sources of fatigue, or to replace them with fasteners 20 and nuts 30 having different drive features for compatibility with different nut plates 40 or fastener plates 60.

Although the invention has been described above with reference to one or more preferred examples or embodiments, it will be appreciated that various changes or modifications may be made without departing from the scope of the invention disclosed herein. For example, the nut plate 40 could be used with any of the fastener plates 60, 70 or the base plates 90, 100; in any combination. The same goes for any other combination of the proposed components.

Where the term “or” has been used in the preceding description, this term should be understood to mean “and/or”, except where explicitly stated otherwise.

1. An assembly for preventing the relative rotation of a fastener and a nut, the assembly comprising a nut plate and fastener plate; wherein:
the fastener comprises a head, a threaded tail and a fastener drive feature in the tail for rotating the fastener;
the nut comprises a threaded hole in which the threaded tail of the fastener is engaged, and a nut drive feature for rotating the nut;
the nut plate comprises a nut plate locking member configured to engage the fastener plate, and a nut drive feature engagement member coupled to the nut drive feature such that the nut cannot rotate relative to the nut plate;
the fastener plate comprises a fastener plate locking member for engaging with the nut plate, and a fastener drive feature engagement member that is coupled to the fastener drive feature such that the fastener cannot rotate relative to the fastener plate; and
the nut plate and fastener plate are coupled together via the nut plate locking member and fastener plate locking member such that the fastener and nut cannot rotate relative to each other.

2. The assembly according to claim 1, wherein the nut has an outer perimeter which is shaped to provide the nut drive feature, for driving the nut by a complementarily shaped tool, and the nut plate defines a nut plate hole in which the nut is received, the shape of the nut plate hole being complementary to at least part of the nut outer perimeter so as to provide the nut drive feature engagement member.

3. The assembly according to claim 1, wherein the fastener drive feature comprises a shaped recess on the end of the threaded tail distal to the head, and the fastener drive feature engagement member comprises a protrusion that is received inside and coupled to the fastener drive feature.

4. The assembly according to claim 1, wherein the nut plate locking member comprises an extended platform around a portion of the circumference of the nut for receiving the fastener plate locking member in different positions depending on the relative angle between the fastener drive feature and the nut drive feature.

5. The assembly according to claim 4, wherein the fastener plate locking member is connected to the fastener plate by an arm that positions the fastener plate locking member adjacent to a portion of the nut plate locking member.

6. The assembly according to claim 1, for preventing the rotation of a fastener and a nut within a workpiece in which they are received and relative to each other, the assembly further comprising a base plate, wherein:
the workpiece comprises a hole extending between first and second sides of the workpiece, the tail of the fastener is received in the workpiece hole, the fastener head is located on the first side of the workpiece and the nut is located on the second side of the workpiece;
the base plate comprises a base plate locking member for engaging with the nut plate and the fastener plate, and base plate securing means for preventing rotation of the base plate relative to the workpiece; further wherein:
the base plate, nut plate and fastener plate are coupled together via the base plate locking member, nut plate locking member and fastener plate locking member such that the fastener and nut cannot rotate relative to each other or to the workpiece.

7. The assembly according to claim 6, wherein the base plate defines a first hole in which the tail of the fastener is received; and
the base plate is positioned between the workpiece and the nut.

8. The assembly according to claim 6, wherein the base defines a second hole, separate to and distant from the first hole, in which a protrusion from the workpiece is received so as to provide the base plate securing means.

9. The assembly according to claim 8, wherein the protrusion from the workpiece comprises a second fastener.

10. The assembly according to claim 6, wherein the nut plate, fastener plate and base plate are coupled together by way of aligned holes in the nut plate locking member, fastener plate locking member and base plate locking member, the assembly further comprising a plate fastener extending through the holes for preventing relative rotation of the nut plate, fastener plate and base plate.

11. A kit of parts for fitting to a fastener and nut to prevent unwanted rotation of the fastener and/or the nut, wherein the fastener comprises a head, a threaded tail and a fastener drive feature in the tail for rotating the fastener, the nut comprises a threaded hole in which the threaded tail of the fastener is engaged, and a nut drive feature for rotating the nut; the kit of parts comprising:
a nut plate, comprising a nut plate locking member and a nut drive feature engagement member for coupling to the nut drive feature such that the nut cannot rotate relative to the nut plate;
a fastener plate, comprising a fastener plate locking member, an arm and a fastener drive feature engagement member for coupling to the fastener drive feature such that the fastener cannot rotate relative to the fastener plate; and
when the nut plate and fastener plate are installed on the nut and fastener respectively, the nut plate locking member and fastener plate locking member are positioned adjacent to each other for securing them together for preventing relative rotation of the nut plate and fastener plate such that relative rotation of the fastener and the nut are prevented.

12. A method for installing a first fastener and first nut in a first hole in a workpiece; the fastener comprising a head, a threaded tail and a fastener drive feature in the tail for rotating the fastener, the nut comprising a threaded hole for engaging with the threaded tail of the fastener and a nut drive feature for rotating the nut; the method being for preventing unwanted relative rotation between the first nut and the first fastener, the method comprising:
inserting the fastener into the hole in the workpiece;
securing the nut on the threaded tail of the fastener on the other side of the hole to the fastener head;
providing a nut plate comprising a nut drive feature engagement member for engaging with the nut drive feature and a nut plate locking member,
coupling the nut plate with the nut drive feature by way of the nut drive feature engagement member;
providing a fastener plate comprising a fastener drive feature engagement member for engaging with the fastener drive feature and a fastener plate locking member;
coupling the fastener plate with the fastener drive feature by way of the fastener drive feature engagement member such that the fastener plate locking member and nut plate fastener plate locking member are positioned adjacent to each other; and
securing the nut plate and fastener plate together by way of the nut plate locking member and fastener plate locking member such that the fastener and nut can no longer rotate relative to each other.

13. The method according to claim 12, further comprising:
providing a base plate, comprising a base plate securing means for securing the base plate to the workpiece and a base plate locking member;
coupling the base plate to the workpiece by way of the base plate securing means; and
securing the base plate, nut plate and fastener plate together by way of the base plate locking member, nut plate locking member and fastener plate locking member, such that the fastener and nut can no longer rotate relative to each other or the workpiece.

14. The method according to claim 12, further comprising:
making a hole that extends through the locking members of the various plates; and
securing a locking fastener through the locking members to secure them together to prevent their relative rotation.

15. The method according to claim 13 for further installing a second fastener and second nut in a second hole in the workpiece, wherein:
the step of providing the base plate comprises providing a base plate comprising a first base plate hole for receiving the first fastener and a second base plate hole for receiving the second fastener, the base plate securing means being provided by the first and second base plate holes being separated from each other such that the base plate cannot rotate around either the first base plate hole or second base plate hole when fasteners extend through them; and
the step of coupling the base plate to the workpiece comprises positioning the base plate over the workpiece and first and second fasteners such that the first fastener is received in the first base plate hole and the second fastener is received in the second base plate hole.
